(19) United States
(12) Patent Application Publication
(10) Pub. No.: US 2009/0323034 A1
(43) Pub. Date: Dec. 31, 2009

(54) Optical Unit and Projection Type Display Apparatus for Displaying an Image

(75) Inventor: Nobuyuki KIMURA, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi , Ltd.

(21) Appl. No.: 12/430,160

(22) Filed: Apr. 27, 2009

(30) Foreign Application Priority Data
Jun. 27, 2008 (JP) 2008-168612

(51) Int. Cl. G03B 21/14

(52) U.S. Cl. 353/97

(57) ABSTRACT

To suppress the reduction of contrast caused by reduction of contrast in the case where a projection type display apparatus for displaying an image is used in a dark place. In a projection type display apparatus for displaying an image which includes a liquid crystal display element unit that modulates and emits incident light, an illumination optical system that allows emission light emitting from a light source to enter the liquid crystal display element unit, and a projection optical system that projects the emission light emitting from the liquid crystal display element unit to a screen, an optical unit includes an iris unit in which light shielding plates shut the amount of light entering the liquid crystal display element unit to be narrowed down as the brightness level of image light projected from the projection optical system is lower, and an open/close angle of each light shielding plate is set at smaller than 90 degrees.

### BACKGROUND OF THE INVENTION

(1) Field of the Invention

The present invention relates to a projection type display apparatus for displaying an image such as a liquid crystal projector apparatus, and particularly to an optical unit using an illumination-system iris.

(2) Description of the Related Arts

With an increasing size of a household television screen in these days, the television screen has been widely used for a home theater in many cases. A liquid crystal projector as a projection type display apparatus for displaying an image has also become widespread for use as a household display device or a household movie projector (home theater) for displaying a broadcasting television image.

In the projection type display apparatus for displaying an image such as a liquid crystal projector, emission light from a light source is projected to a screen while being modulated using a liquid crystal panel as a spatial light modulation element. The liquid crystal projection apparatus has been decreasing in size and weight. Accordingly, since a small-sized image is projected to a large-sized screen, the amount of projection light is increased or the F-value of a lens is decreased in order to maintain the characteristics of the apparatus. However, in the case of displaying a dark image, reduction of contrast occurs.

The contrast of an image is reduced by the reduction of contrast. The reduction of the contrast is more noticeable in dark environments than in bright environments. Therefore, in the case where the apparatus is used for household when watching a movie and the like in a home theater-like environment in a state where the illumination of the room is reduced, the reduction of the contrast caused by the reduction of contrast is regarded as deterioration of the image quality.

In Japanese Patent Application Laid-Open No. 2003-107422, in order to suppress the reduction of contrast, a light shutter for shutting light in descending order of incident angles with respect to a liquid crystal panel is arranged in any one of an illumination optical system and a projection optical system, and the light is shut by surrounding light detecting means for detecting the amount of light surrounding a liquid crystal projector apparatus and the light shutter in accordance with lowering of the amount of light detected by the surrounding light detecting means. However, the light is shut in accordance with the amount of light surrounding the liquid crystal projector apparatus, and the amount of light is not changed depending on whether a projection image is dark or bright.

### SUMMARY OF THE INVENTION

Specifically, the present invention is to provide a projection type display apparatus for displaying an image such as a liquid crystal projector apparatus with less reduction of contrast caused by reduction of contrast even in the case where the brightness of a projection image itself is lower at a place where illumination is reduced.

The present invention provides an optical unit of a projection type display apparatus for displaying an image which projects an image, the apparatus including: an image display element unit which modulates and emits incident light in accordance with an image signal of the image; a light source unit; a projection optical system which projects the emission light from the image display element unit to a screen; an optical unit which allows the emission light from the light source unit to enter the image display element unit; and a control unit,

the optical unit including a reflex lens, a first integrator, a second integrator whose effective size is larger than that of the first integrator, a polarization beam splitter, a collecting lens, and an iris unit, wherein the iris unit is arranged between the first integrator and the second integrator, and includes a pair of light shielding plates, each rotating about a predetermined position as a rotation center, and a driving unit which rotates the light shielding plates, and the control unit changes a rotation angle of each light shielding plate to increase a stop-down level by controlling the driving unit in accordance with lowering of a brightness level of the image signal modulated by the image display element unit.

Preferably, in the optical unit of the projection type display apparatus for displaying an image according to the present invention, in the case where the brightness level of the image signal is smaller than a predetermined first value, the iris unit maximizes the stop-down level.

Preferably, in the optical unit of the projection type display apparatus for displaying an image according to the present invention, in the case where the brightness level of the image signal is a predetermined second value or larger, the iris unit minimizes the stop-down level.

Preferably, in the optical unit of the projection type display apparatus for displaying an image according to the present invention, the maximum angle of the rotation angle of each light shielding plate of the iris unit is smaller than 90 degrees.

Preferably, in the optical unit of the projection type display apparatus for displaying an image according to the present invention, an angle formed by a position where each light shielding plate of the iris unit stops and a line in parallel to an optical axis which is emitted from the light source unit to reach the polarization beam splitter when the stop-down level is minimum is a predetermined first angle or larger.

Preferably, in the optical unit of the projection type display apparatus for displaying an image according to the present invention, the predetermined first angle is 5 degrees.

Preferably, in the optical unit of the projection type display apparatus for displaying an image according to the present invention, an angle formed by a position where each light shielding plate of the iris unit stops and a line perpendicular to the optical axis which is emitted from the light source unit to reach the polarization beam splitter when the stop-down level is maximum is a predetermined second angle or larger.

Preferably, in the optical unit of the projection type display apparatus for displaying an image according to the present invention, the predetermined second angle is 5 degrees.

Preferably, in the optical unit of the projection type display apparatus for displaying an image according to the present invention, the reflex lens of the optical unit diffuses the light emitted from the light source unit.

Further, the present invention provides a projection type display apparatus for displaying an image, including: an image display element unit which modulates and emits incident light in accordance with an image signal; a light source unit; an optical unit which allows the emission light from the light source unit to enter the image display element unit; a projection optical system which projects the emission light from the image display element unit to a screen; and a control unit, wherein the optical unit includes a reflex lens, a first integrator, a second integrator whose effective size is larger than that of the first integrator, a polarization beam splitter, a collecting lens, and an iris unit, the iris unit is arranged between the first integrator and the second integrator, and includes a pair of light shielding plates, each rotating about a predetermined position as a rotation center, and a driving unit which rotates the light shielding plates, and the control unit controls the driving unit in accordance with lowering of a brightness level of the image signal modulated by the image display element unit and changes a rotation angle of each light shielding plate to control a stop-down level.

Preferably, in the projection type display apparatus for displaying an image according to the present invention, in the case where the brightness level of the image signal is smaller than a predetermined first value, the control unit controls the iris unit to maximize the stop-down level.

Preferably, in the projection type display apparatus for displaying an image according to the present invention, in the case where the brightness level of the image signal is a predetermined second value or larger, the control unit controls the iris unit to minimize the stop-down level.

According to the present invention, in the case where a projection type display apparatus for displaying an image such as a liquid crystal projector apparatus is used in a dark place, it is possible to suppress the reduction of contrast caused by reduction of contrast, especially when a dark image is projected.

### BRIEF DESCRIPTION OF THE DRAWINGS

FIG. 1 is a diagram showing an embodiment of an optical system configuration of a projection type display apparatus for displaying an image according to the present invention;

FIG. 2 is a diagram showing an example of an open/close system of an iris unit;

FIG. 3 is a diagram showing an example of an open/close system of the iris unit;

FIG. 4 is a diagram showing an example of an open/close system of the iris unit;

FIG. 5 is a diagram for explaining a configuration of the iris unit of the embodiment of the projection type display apparatus for displaying an image according to the present invention;

FIG. 6 is a diagram for explaining the embodiment of the iris unit according to the present invention;

FIGS. 7A and 7B are diagrams, each explaining a state in which the iris unit according to the present invention is embedded;

FIG. 8 is a diagram showing a configuration of the embodiment of the projection type display apparatus for displaying an image according to the present invention;

FIG. 9 is a diagram for explaining a configuration of the iris unit of the embodiment of the projection type display apparatus for displaying an image according to the present invention; and

FIGS. 10A to 10C are diagrams, each showing a result obtained by calculating a light path from a light source to a polarization beam splitter (PBS) using an angle, as a parameter, when light shielding plates are fully opened in the iris unit of the embodiment of the projection type display apparatus for displaying an image according to the present invention.

### DETAILED DESCRIPTION OF THE ILLUSTRATED EMBODIMENT

Hereinafter, embodiments of the present invention will be described in detail with reference to the accompanying drawings. Constituent elements having the common functions are given the same reference numerals in the explanations for the respective drawings, and the explanations will be omitted in order to avoid duplication as much as possible.

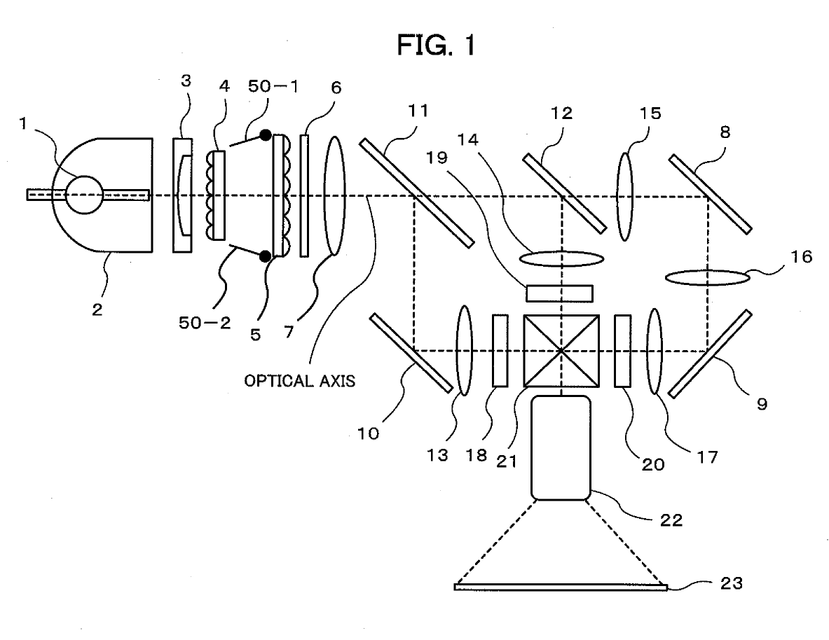

FIG. 1 is a diagram showing an embodiment of a configuration of an optical system of a projection type display apparatus for displaying an image according to the present invention. The reference numeral 1 denotes a light source, 2 denotes a reflector, 3 denotes a reflex lens, 4 denotes a first integrator, 50-1 denotes a left light shielding plate (shielding plate) of an iris unit, 50-2 denotes a right light shielding plate (shielding plate) of the iris unit, 5 denotes a second integrator, 6 denotes a polarization beam splitter (PBS), 7 denotes a collecting lens, 8 to 10 denote reflecting mirrors, 11 and 12 denote dichroic mirrors as color separating means, 13 and 14 denote condenser lenses, 15 denotes a first relay lens, 16 denotes a second relay lens, 17 denotes a third relay lens, 18 to 20 denote image display elements (light liquid panels), 21 denotes a photosynthetic prism, 22 denotes a projection lens, and 23 denotes a screen. The left light shielding plate 50-1 and the right light shielding plate 50-2 are a part of the configuration of the iris unit 50.

The light source 1 is a white lamp such as an ultrahigh-pressure mercury lamp, a metal halide lamp, a xenon lamp, a mercury xenon lamp, and a halogen lamp. The reflector 2 has an elliptical reflecting plane, and has an emission aperture, for example, in a circular or polygonal shape. In addition, the light source 1 and the reflector 2 are referred to as a light source unit.

The polarization beam splitter 6 is a filter which separates incident light in accordance with its polarization components (a P polarization component passes through a filter plane and an S polarization component is reflected by the filter plane). The left light shielding plate 50-1 and the right light shielding plate 50-2 as a pair of light shielding plates of the iris unit are symmetric with respect to an optical axis.

In FIG. 1, light emitted from the light source 1 is reflected by the reflector 2 to be emitted to the first integrator 4 through the reflex lens 3 as light in substantially parallel to the optical axis. The first integrator 4 is configured in such a manner that plural lens cells are arranged in a matrix manner, and divides the incident light from the reflex lens 3 into plural lights to be efficiently guided to the second integrator 5 and the polarization beam splitter 6 through the iris unit 50. The polarization beam splitter 6 aligns the lights from the second integrator 5 in a predetermined polarization direction.

The polarized lights are collected by the collecting lens 7 to be separated into a light R (red-color light), a light B (blue-color light), and a light G (green-color light) by the dichroic mirrors 11 and 12 in accordance with colors.

The light R is reflected by the dichroic mirror 11, and is then reflected by the reflecting mirror 10 to enter a light-R liquid crystal panel 18 through the condenser lens 13.

Of the light B and the light G which pass through the dichroic mirror 11, the light-B is reflected by the dichroic mirror 12 to enter a light-B liquid crystal panel 19 through the condenser lens 14.

In the meantime, the light G passes through the dichroic mirror 12, and is reflected by the reflecting mirrors 8 and 9 to enter a light-G liquid crystal panel 20 through the relay lenses 15, 16, and 17. The light G is longer than the other lights R and B in the light path lengths up to the liquid crystal panels where each light of three colors enters.

Projection images of the respective lens cells of the first integrator 4 are superimposed on the liquid crystal panels by the optical system (illumination means) through the collecting lens 7, the condenser lenses 13 and 14, and the relay lenses 15 to 17.

Specifically, the first integrator 4 and the liquid crystal panels 18 to 20 are arranged to be in a relation (conjugate relation) of an object and an image.

The second integrator 5 and the collecting lens 7 irradiate the plural light fluxes divided by the first integrator 4 to the respective liquid crystal panels 18 to 20 with high-uniformity illuminance distribution. As described above, the uniform illuminance distribution can be obtained by the illumination means between the first integrator 4 and the liquid crystal panels 18 to 20.

The light path of the light G will now be further described. The light G passes through the dichroic mirror 12, and is reflected by the reflecting mirror 8 to be imaged once at the position optically conjugate to the liquid crystal panel 20. Further, the light G is imaged again on the light-G liquid crystal panel 20 by the action of the first relay lens 15, the reflecting mirror 8, the second relay lens 16, the reflecting mirror 9, and the third relay lens 17.

The optical system between the first relay lens 15 and the third relay lens 17 is referred to as a relay lens system. As described above, even in the case where the length of the light-G path is longer than each of those of the other light-R and light-B paths, the light G can be corrected so as to be imaged at a normal position by providing the relay lens system.

An optical image is formed by being optically modulated in accordance with an image signal (not shown) in the respective liquid crystal panels 18 to 20. The light R, the light B, and the light G which pass through these liquid crystal panels 18 to 20 are combined as a color image by the photosynthetic prism (photosynthetic means) 21. Thereafter, the combined light passes through the projection lens (projection optical system) 22 such as a zoom lens, and is enlarged and projected to the screen 23.

In order to avoid complication, only main constituent elements for explaining the function of the illumination optical system are illustrated and explained in FIG. 1.

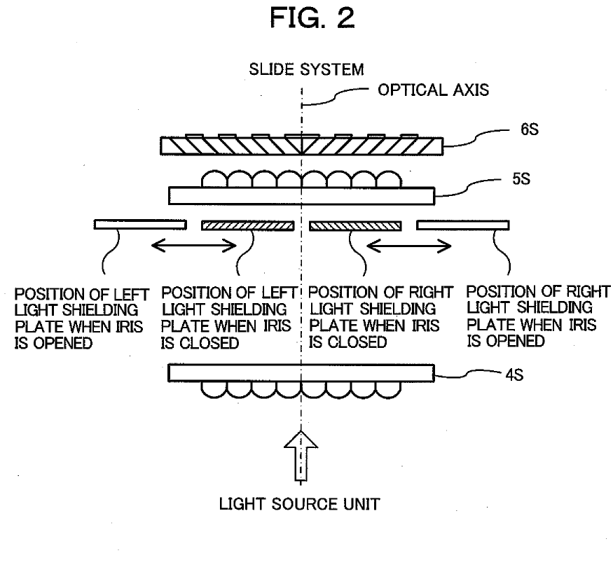

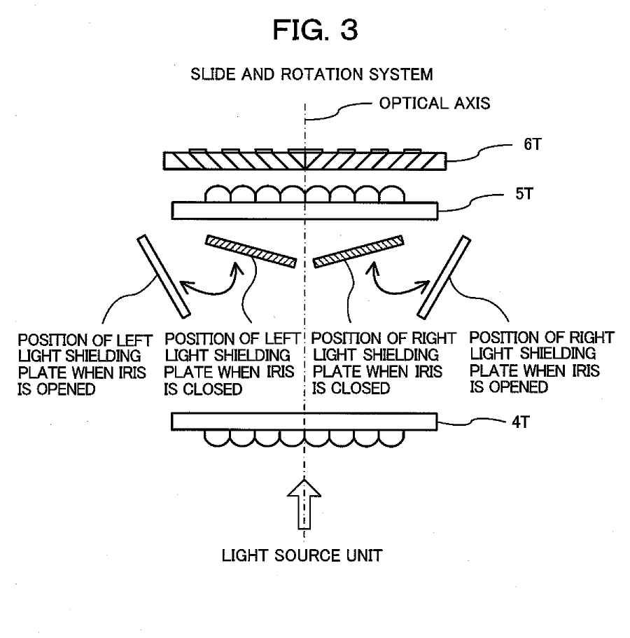

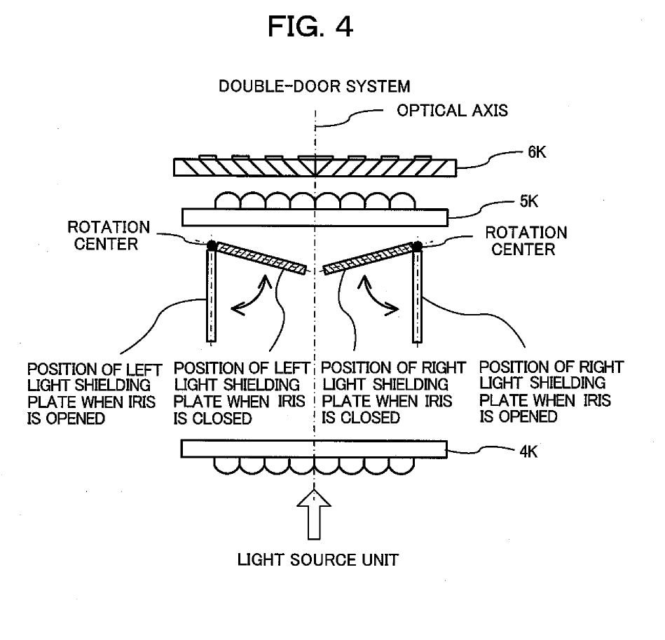

Next, the iris unit of the present invention will be described hereinbelow using the drawings. The iris unit is provided between the first integrator and the second integrator, and employs an open/close system which changes the width of the light path by mechanically changing the open/close angles of the light shielding plates to control the amount of passing light. The open/close system of the light-shielding plates is considered to be the same as that of a door, and the systems shown in FIGS. 2 to 4 are given. The open/close system of FIG. 2 is a slide system by which the light shielding plates are perpendicularly moved with respect to the optical axis of passing light. The open/close system of FIG. 3 is a slide and rotation system obtained by adding a rotational function to the slide method. In these open/close systems of FIGS. 2 and 3, a movement distance or a motional range of sliding is large, and a double-door system as shown in FIG. 4 can downsize the set size of the apparatus to the minimum.

In FIGS. 2 to 4, the reference numerals 4S, 4T, and 4K denote the first integrators, 5S, 5T, and 5K denote the second integrators, and 6S, 6T, and 6K denote the polarization beam splitters (PBSs). Further, the light emitted from the light source (not shown) located on the lower side is directed to the upper side, and then reaches the collecting lens 7 through the polarization beam splitters (PBSs) 6S, 6T, or 6K.

### First Embodiment

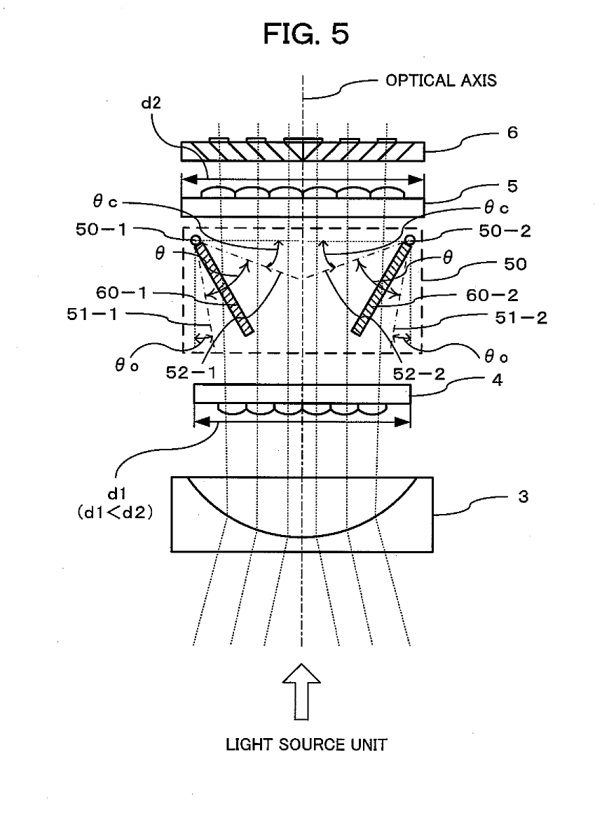

An embodiment of the present invention will be described with reference to FIG. 5. FIG. 5 is a diagram for explaining a configuration of the iris unit of the embodiment of the projection type display apparatus for displaying an image according to the present invention. The reference numeral 50 denotes the iris unit, 50-1 denotes a rotation center of the left light shielding plate of the iris unit 50, 50-2 denotes a rotation center of the right light shielding plate of the iris unit 50, 51-1 denotes the position of the left light shielding plate when the iris is fully opened, 51-2 denotes the position of the right light shielding plate when the iris is fully opened, 52-1 denotes the position of the left light shielding plate when the iris is fully closed, and 52-2 denotes the position of the right light shielding plate when the iris is fully closed.

In FIG. 5, the light emitted from the light source unit (not shown) located on the lower side is directed to the upper side to reach the collecting lens 7 through the polarization beam splitter (PBS) 6.

It should be noted that the light source unit is configured by the light source 1 such as a discharge lamp and the reflector 2 which directs light (unpolarized light) emitted from the light source 1 in a given direction (see FIG. 1).

The light emitted from the light source unit is emitted to the reflex lens 3. The reflex lens 3 polarizes the incident light to the direction outside the light in parallel to the direction of the optical axis to emit the same to the first integrator 4. The first integrator 4 divides the incident light into plural lights, and further diffuses the same to the outside of the optical axis so as to be emitted to the second integrator 5 through the iris unit 50. The diffusion angle of the first integrator 4 is in a range of 10 degrees to 32 degrees.

The second integrator 5 polarizes plural incident lights to be converged towards the inside of the optical axis, and emits the same to the polarization beam splitter (PBS) 6.

The polarization beam splitter (PBS) 6 is a filter through which the incident light is separated from each other in accordance with its polarization components (a P polarization component passes through a filter plane and an S polarization component is reflected by the filter plane) and aligns the lights in a predetermined polarization direction to be emitted to the collecting lens 7.

When the light emitted from the light source unit passes from the first integrator 4 towards the second integrator 5, the iris unit 50 controls the amount of passing light by opening or closing the left light shielding plate and the right light shielding plate in accordance with the illuminance value of the image projected by the projection type display apparatus for displaying an image.

When the stop-down level of the iris unit 50 is minimum, it is most efficient that all the light passing through the first integrator 4 enters the second integrator 5. Further, when the stop-down level of the iris unit 50 is maximum, the light shielding plates are set at a fully-closed position. When the light shielding plates are fully opened, the stop-down level is minimum.

In the first embodiment of the present invention, an effective size d2 of the second integrator is larger than an effective size d1 of the first integrator 4 as shown in FIG. 5.

The effective size of the integrator is defined as the size of the lens. Accordingly, even when the light shield plates 60-1 and 60-2 are located at the fully-opened position (the minimum level of stop-down), θo (an angle formed by the position of the fully-opened left light shielding plate 60-1 and the optical axis with the rotation center 50-1 serving as a midpoint, and an angle formed by the position of the fully-opened right light shielding plate 60-2 and the optical axis with the rotation center 50-2 serving as a midpoint) is not 0 degree (not parallel). In addition, even when the stop-down level of the light shielding plates 60-1 and 60-2 is maximum, θc (an angle formed by the left light shielding plate 60-1 and the line perpendicular to the optical axis with the rotation center 50-1 serving as a midpoint, and an angle formed by the right light shielding plate 60-2 and the line perpendicular to the optical axis with the rotation center 50-2 serving as a midpoint) is not 0 degree. Further, a maximum value θ of the open/close angle of each of the light shielding plates 60-1 and 60-2 is less than 90 degrees (for example, 60 degrees). Even when the stop-down level of the iris unit is maximum, each of the light shielding plates 60-1 and 60-2 has a predetermined angle θc (θc>0 degree, for example, θc is 5 degrees, 10 degrees, 30 degrees, or the like) with respect to the plane perpendicular to the optical axis. Even when the stop-down level of the iris unit is minimum, each of the light shielding plates 60-1 and 60-2 has a predetermined angle θo (θo>0 degree, for example, θo is 5 degrees, 10 degrees, 30 degrees, or the like) with respect to the optical axis.

As described above, since the rotation open/close angle of each of the light shielding plates is less than 90 degrees (for example, 60 degrees), the rotation angle (rotation range) is smaller than an angle difference of 90 degrees between the angle when the stop-down level of the iris unit is maximum and the angle when the stop-down level of the iris unit is minimum, thus realizing the iris unit with a fast open/close speed. Further, since the rotation range is small, the iris unit is accordingly made small (for example, the distance between the first integrator and the second integrator can be shortened), thus realizing a downsized set of the apparatus. Further, since the distance between the first integrator and the second integrator can be shortened, the attenuation amount of the output of the light source 1 can be decreased, namely, the maximum amount of light can be increased.

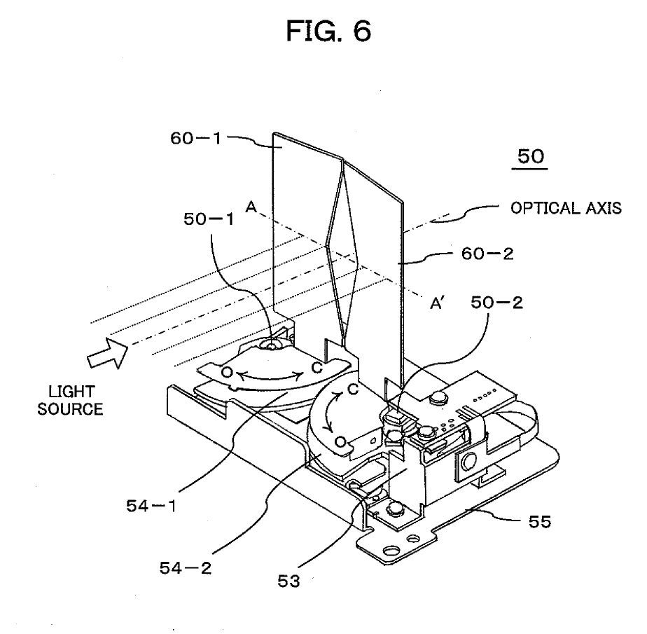

FIG. 6 is an exterior perspective view of the embodiment of the iris unit according to the present invention. The reference numeral 50-1 denotes the rotation center of the left light shielding plate of the iris unit 50, 50-2 denotes the rotation center of the right light shielding plate of the iris unit 50, 60-1 denotes the left light shielding plate, and 60-2 denotes the right light shielding plate. In addition, a horizontal plane which passes through the line A-A′ of FIG. 6 is a plane shown in FIG. 5. It should be noted that FIG. 5 illustrates both cases in which the right and left light shielding plates are opened and closed, whereas FIG. 6 illustrates a state in which each rotational position of the right and left light shielding plates is perpendicular to the optical axis.

Further, the reference numeral 53 denotes a motor unit, and 54-2 denotes a gear which rotates in the arrow direction along with the rotation of the motor unit 53. The reference numeral 54-1 denotes a gear which is engaged with the gear 54-2 and rotates along with the rotation of the gear 54-2, and 55 denotes a chassis. The arrow in the “O” direction represents the rotational direction of the light shielding plates in the case of decreasing a stop-down level, and the arrow in the “C” direction represents the rotational direction of the light shielding plates in the case of increasing a stop-down level. The components to be mounted are attached to the chassis 55, and the chassis 55 is further attached to the projection type display apparatus for displaying an image according to the present invention as a part of the configuration.

The light which is emitted from the light source unit (the light source 1 and the reflector 2) and passes through the reflex lens 3 enters from the direction of the arrow to the direction of the dotted line, and enters the second integrator 5 after the amount of light is adjusted through an aperture of the left and right light shielding plates 60-1 and 60-2 of the iris unit 50. The motor unit 53 rotates to open and close the left and right light shielding plates 60-1 and 60-2 with a signal from a control unit (to be described later) for controlling the iris unit 50, and transmits the rotation power to the gears 54-1 and 54-2 to change the rotation angles of the gears 54-1 and 54-2. By changing the open and close angles of the left and right light shielding plates 60-1 and 60-2 with the rotation angles of the gears 54-2 and 54-1, the amount of light which passes through the iris unit 50 is adjusted.

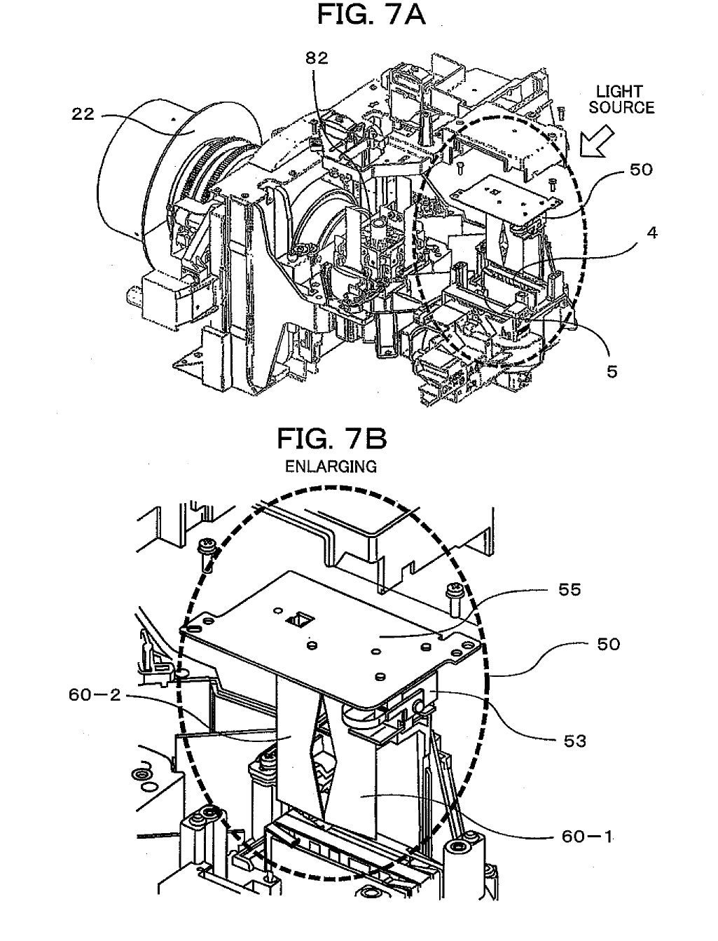

FIGS. 7A and 7B are diagrams each explaining a state in which the iris unit 50 explained in the first embodiment is embedded into the projection type display apparatus for displaying an image according to the present invention. FIG. 7A is a perspective view for showing an optical system portion which is a part of the projection type display apparatus for displaying an image according to the present invention. The reference numeral 4 denotes the first integrator, 5 denotes the second integrator, 50 denotes the iris unit, 82 denotes an optical unit, and 22 denotes the projection lens. Further, FIG. 7B is an enlarged view of the dashed circular portion of FIG. 7A.

In FIGS. 7A and 7B, the iris unit 50 is embedded between the first integrator 4 and the second integrator 5 while inverting its front side and back side and its upside and downside from the position of FIG. 6.

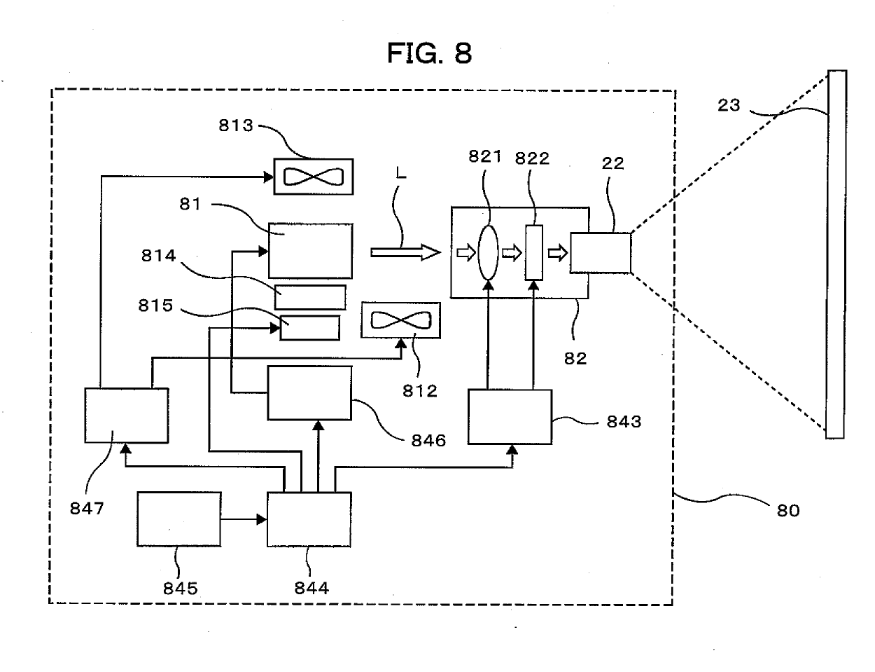

FIG. 8 is a block diagram showing an outline configuration of the projection type display apparatus for displaying an image according to the embodiment of the present invention. The reference numeral 80 denotes the projection type display apparatus for displaying an image, 23 denotes the screen, 81 denotes the light source unit, 82 denotes the optical unit, 821 denotes an illumination optical system of the optical unit 82, 822 denotes an image display element unit (liquid crystal panel unit) of the optical unit 82, 22 denotes the projection lens of the optical unit 82, 843 denotes a display driving circuit, 844 denotes a control unit, 845 denotes an operation unit which is an MMI (Man Machine Interface) of the apparatus operated by a user, 846 denotes a light-source power source circuit, 847 denotes a fan power source circuit, 812 denotes an inner cooling fan of the light source unit 81, 813 denotes an outer surface cooling fan of the light source unit 81, 814 denotes a duct, and 815 denotes an air volume adjusting shutter.

The illumination optical system 821 includes, for example, the reflex lens 3, the first integrator 4, the iris unit 50, the second integrator 5, the polarization beam splitter (PBS) 6, and the collecting lens 6 of FIG. 5.

In the projection type display apparatus 80 for displaying an image of FIG. 8, a light L emitted from the light source unit 81 enters the optical unit 82. The illumination optical system 821 uniforms the light amount distribution of the light L from the light source unit 81 to be irradiated to the image display element unit 822. The image display element unit 822 is driven by the display driving circuit 843, and forms a display light obtained by modulating the light L with an optical image (not shown) in accordance with an image signal. The display light formed is projected from the emission aperture of the projection lens 22 to a screen provided outside or an irradiation plane 23 such as a wall plane.

The arrows of the light L and the like emitted from the light source unit 81 in FIG. 8 are only schematically illustrated for explanation, and the arrangements, angles, sizes, and directions of the light are not accurate. Further, the optical system for each of three colors explained in FIG. 1 is actually omitted in the image display element unit 82.

In FIG. 8, the projection type display apparatus for displaying an image is controlled by the control unit 844 configured by a CPU (Central Processing Unit) operated in accordance with a program that is stored in a ROM (Read Only Memory) or the like. The control unit 844 performs a predetermined process in response to a button of the operation unit 845 operated in a button operation by a user. For example, the control unit 844 turns on or off the light source of the light source unit 81 through the light-source power source circuit 846, and in accordance with the turning-on or turning-off of the light source, the control unit 844 operates or stops the inner cooling fan 812 of the light source unit 81, the outer surface cooling fan 813 of the light source unit 81, the duct 814, and the air volume adjusting shutter 815 through the fan power source circuit 847. In addition, the control unit 844 controls the display driving circuit 843 to display an image.

Further, the display driving circuit 843 detects the brightness of the display light formed by the image display element unit 822, and controls an open/close angle of the iris unit 50 of the illumination optical system 821 on the basis of the detected brightness value. For example, a brightness value for each frame of the original image signal of the display light to be formed is detected. In the case where the brightness value is a predetermined value P or larger, the light shielding plates 60-1 and 60-2 are put in a fully-opened state (the minimum level of stop-down, namely, the maximum amount of transmission light). In the case where the brightness value is a predetermined value Q or smaller, the light shielding plates 60-1 and 60-2 are put in a fully-closed state (the maximum level of stop-down, namely, the minimum amount of transmission light). In the case where the brightness value is between the predetermined value P and the predetermined value Q, the open/close angles of the light shielding plates are changed stepwise.

The detection of the brightness value may be performed using, for example, a well-known AGC (Auto Gain Control) function. Further, the brightness value may be calculated as an average value of each pixel using, for example, an image processing function, or may be calculated as an average value of each pixel for a predetermined area.

Alternatively, such as a well-known scene changing point detection technique, the brightness value is detected and the iris may be controlled so as to become the amount of light corresponding to the detected brightness value.

Further, the iris may be controlled for each frame, but the iris may be controlled for plural frames.

Furthermore, the display driving circuit 843 detects the brightness of the display light formed by the image display element unit 822, and controls the open/close angle of the iris unit 50 of the illumination optical system 821 on the basis of the detected brightness value in the above-described embodiment. However, by receiving information of the brightness value of the image signal from the display driving circuit 843 by the control unit 844, the control unit 844 may directly control the open/close angle of the iris unit 50 of the illumination optical system 821.

Furthermore, the control unit 844 includes at least any one of the display driving circuit 843, the light-source power source circuit 846 and the fan power source circuit 847, and may be provided with these functions.

As a result, in the case where the brightness of the display light to be projected is large, the light emitted from the light source unit is projected as it is or with a predetermined amount of light. As the brightness of the display light to be projected becomes smaller, the light emitted from the light source unit is narrowed down. Accordingly, the amount of projection light can be changed in accordance with the brightness of the display light or the image signal, and thus it is possible to suppress reduction of contrast and to realize a projection type display apparatus for displaying an image with less reduction of image contrast.

### Second Embodiment

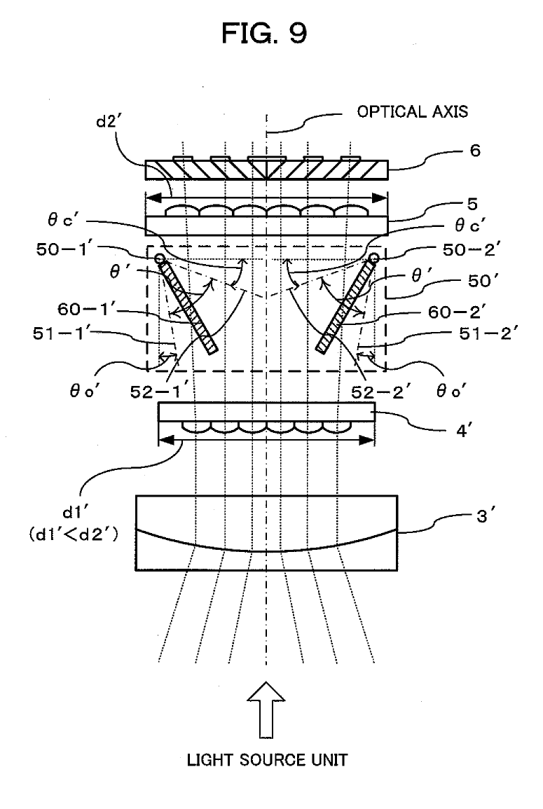

Another embodiment of the present invention will be described with reference to FIG. 9. FIG. 9 is a diagram for explaining a configuration of the iris unit of the embodiment of the projection type display apparatus for displaying an image according to the present invention. The reference numeral 50′ denotes the iris unit, 50-1′ denotes the rotation center of the left light shielding plate of the iris unit 50′, 50-2′ denotes the rotation center of the right light shielding plate of the iris unit 50′, 51-1′ denotes the position of the left light shielding plate when the iris is fully opened, 51-2′ denotes the position of the right light shielding plate when the iris is fully opened, 52-1′ denotes the position of the left light shielding plate when the iris is fully closed, 52-2′ denotes the position of the right light shielding plate when the iris is fully closed, 3′ denotes the reflex lens, 4′ denotes the first integrator, 5′ denotes the second integrator, θ′ denotes the maximum open/close angle of each light shielding plate, θc′ denotes the angle formed by the light shielding plate and the line perpendicular to the optical axis when the stop-down level is maximum with the rotation center 50-1′ or 50-2′ as the center, θo′ denotes the angle formed by the light shielding plate and the optical axis when the stop-down level is minimum with the rotation center 50-1′ or 50-2′ as the center, d1′ denotes the effective size of the first integrator 4′, and d2′ denotes the effective size of the second integrator 5′.

In FIG. 9, as similar to FIG. 5, the light emitted from the light source unit (not shown) located on the lower side is directed to the upper side to reach the collecting lens 7 through the polarization beam splitter (PBS) 6.

It should be noted that the light source unit is configured by the light source 1 such as a discharge lamp and the reflector 2 which directs light (unpolarized light) emitted from the light source 1 in a given direction (see FIG. 1).

A difference between FIG. 9 and the embodiment of FIG. 5 is that the magnification of the reflex lens 3′ is made lower than that of the reflex lens 3, and the light that passes through the reflex lens 3′ enters the first integrator 4′ in parallel thereto. As compared to the embodiment of FIG. 5, the distance between the first integrator and the second integrator becomes longer. However, even if manufacturing errors in mechanical accuracy and the like are large, they do not affect optical misalignment as compared to FIG. 5, thus reducing the manufacturing cost.

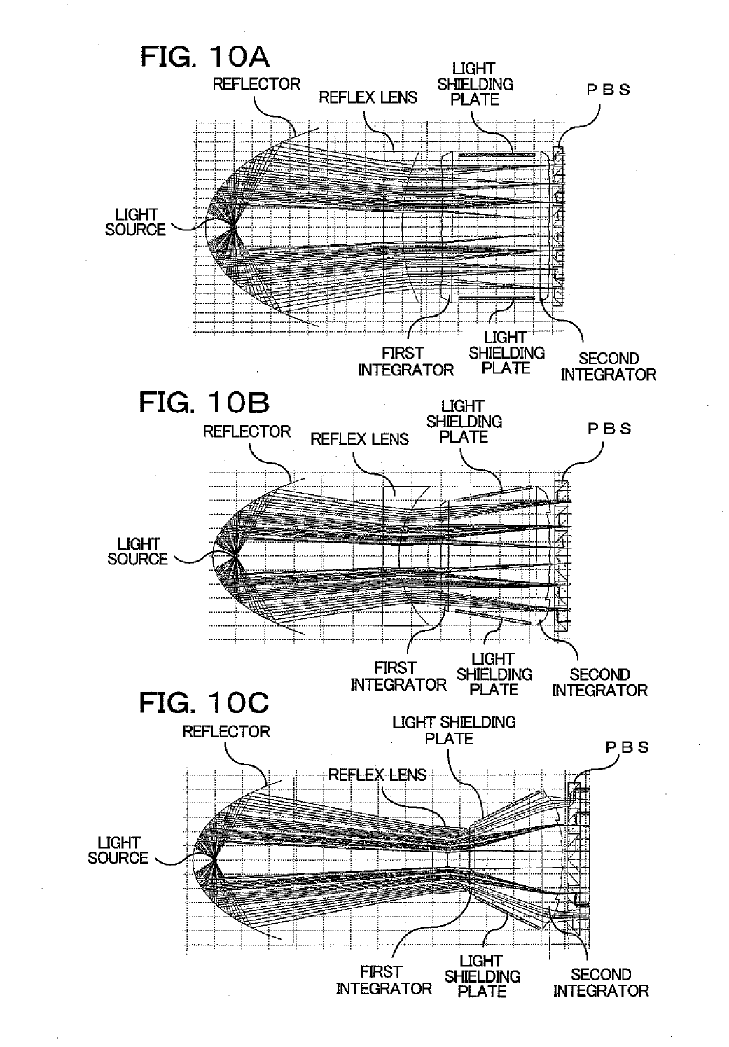

Next, a relation between the open/close angle of each light shielding plate of the iris unit of the projection type display apparatus for displaying an image according to the present invention and the distance between the first integrator and the second integrator will be described with reference to FIGS. 10A to 10C. FIGS. 10A to 10C are diagrams, each showing a result obtained by calculating the light path from the light source to the polarization beam splitter (PBS) using the angle, as a parameter, when the light shielding plates are fully opened in the iris unit of the projection type display apparatus for displaying an image according to the present invention.

FIG. 10A is a calculation result when a divergent angle θd is 0 degree, and a radius of curvature R of the reflex lens is 48 mm, the distance between the first integrator and the second integrator is 35 mm, the angle (angle formed by the optical axis and the position when the light shielding plates are fully opened) θo of each light shielding plate is 0 degree, and a variable angle is 80 degrees. Further, FIG. 10B is a calculation result when the divergent angle is 10 degrees, and the radius of curvature R of the reflex lens is 35 mm, the distance between the first integrator and the second integrator is 30 mm, the angle (angle formed by the optical axis and the position when the light shielding plates are fully opened) θo of each light shielding plate is 10 degrees, and the variable angle is 70 degrees. Furthermore, FIG. 10C is a calculation result when the divergent angle is 32 degrees, and the radius of curvature R of the reflex lens is 12 mm, the distance between the first integrator and the second integrator is 25 mm, the angle (angle formed by the optical axis and the position when the light shielding plates are fully opened) θo of each light shielding plate is 30 degrees, and the variable angle is 50 degrees.

As shown in FIGS. 10A to 10C, by decreasing the effective size d1 of the first integrator smaller than the effective size d2 of the second integrator, the open/close angle of the iris unit is made small in the present invention. As a result, the present invention realizes the iris unit with a fast open/close speed.

Furthermore, by slightly diverging the light after the reflex lens, the distance between the first integrator and the second integrator is shortened. As a result, the illuminance can be increased. Specifically, shortening the distance between the first integrator and the second integrator up to the tip end positions of the light shielding plates overcomes the problem that the integrator can not be manufactured due to a largely-biased core of the integrator though the illuminance in the design can be increased.

According to the above-described embodiments, it is possible to provide the projection type display apparatus for displaying an image with high contrast which can realize the iris unit with a fast open/close speed and a bright illumination system.

The projection type display apparatus for displaying an image to which the present invention is applied may be any one of a three-plate transmission type, a single-plate transmission type, a three-plate reflection type, and a single-plate reflection type.

Further, it is obvious that the present invention is not limited to the above-describe examples, but may be configured in various manners without departing from the gist of the present invention.

What is claimed is:

1. An optical unit of a projection type display apparatus for displaying an image which projects an image, the apparatus comprising:
an image display element unit which modulates and emits incident light in accordance with an image signal of the image;
a light source unit;
a projection optical system which projects the emission light emitting from the image display element unit to a screen;
an optical unit which allows the emission light emitting from the light source unit to enter the image display element unit; and
a control unit,
the optical unit comprising a reflex lens, a first integrator, a second integrator whose effective size is larger than that of the first integrator, a polarization beam splitter, a collecting lens, and an iris unit,
wherein the iris unit is arranged between the first integrator and the second integrator, and includes a pair of light shielding plates, each rotating about a predetermined position as a rotation center, and a driving unit which rotates the light shielding plates, and
the control unit changes a rotation angle of each light shielding plate to increase a stop-down level by controlling the driving unit in accordance with lowering of a brightness level of the image signal modulated by the image display element unit.

2. The optical unit of the projection type display apparatus for displaying an image according to claim 1,
wherein in the case where the brightness level of the image signal is smaller than a predetermined first value, the iris unit maximizes the stop-down level.

3. The optical unit of the projection type display apparatus for displaying an image according to claim 1,
wherein in the case where the brightness level of the image signal is a predetermined second value or larger, the iris unit minimizes the stop-down level.

4. The optical unit of the projection type display apparatus for displaying an image according to claim 1,
wherein the maximum angle of the rotation angle of each light shielding plate of the iris unit is smaller than 90 degrees.

5. The optical unit of the projection type display apparatus for displaying an image according to claim 1,
wherein an angle formed by a position where each light shielding plate of the iris unit stops and a line in parallel to an optical axis which is emitted from the light source unit to reach the polarization beam splitter when the stop-down level is minimum is a predetermined first angle or larger.

6. The optical unit of the projection type display apparatus for displaying an image according to claim 5,
wherein the predetermined first angle is 5 degrees.

7. The optical unit of the projection type display apparatus for displaying an image according to claim 1,
wherein an angle formed by a position where each light shielding plate of the iris unit stops and a line perpendicular to the optical axis which is emitted from the light source unit to reach the polarization beam splitter when the stop-down level is maximum is a predetermined second angle or larger.

8. The optical unit of the projection type display apparatus for displaying an image according to claim 7,
wherein the predetermined second angle is 5 degrees.

9. The optical unit of the projection type display apparatus for displaying an image according to claim 1,
wherein the reflex lens of the optical unit diffuses the light emitted from the light source unit.

10. A projection type display apparatus for displaying an image, comprising:
an image display element unit which modulates and emits incident light in accordance with an image signal;
a light source unit;
an optical unit which allows the emission light emitting from the light source unit to enter the image display element unit;
a projection optical system which projects the emission light emitting from the image display element unit to a screen; and
a control unit,
wherein the optical unit includes a reflex lens, a first integrator, a second integrator whose effective size is larger than that of the first integrator, a polarization beam splitter, a collecting lens, and an iris unit, wherein
the iris unit is arranged between the first integrator and the second integrator, and includes a pair of light shielding plates, each rotating about a predetermined position as a rotation center, and a driving unit which rotates the light shielding plates, and
the control unit controls the driving unit in accordance with lowering of a brightness level of the image signal modulated by the image display element unit and changes a rotation angle of each light shielding plate to control a stop-down level.

11. The projection type display apparatus for displaying an image according to claim 10,
wherein in the case where the brightness level of the image signal is smaller than a predetermined first value, the control unit controls the iris unit to maximize the stop-down level.

12. The projection type display apparatus for displaying an image according to claim 10,
wherein in the case where the brightness level of the image signal is a predetermined second value or larger, the control unit controls the iris unit to minimize the stop-down level.
